(19) United States
(12) Patent Application Publication
(10) Pub. No.: US 2014/0250289 A1
(43) Pub. Date: Sep. 4, 2014

(54) Branch Target Buffer With Efficient Return Prediction Capability

(71) Applicant: MIPS TECHNOLOGIES, INC., Sunnyvale, CA (US)

(72) Inventors: Parthiv POTA, Cupertino, CA (US); Sanjay PATEL, San Ramon, CA (US)

(73) Assignee: MIPS Technologies, Inc., Sunnyvale, CA (US)

(21) Appl. No.: 13/782,600

(22) Filed: Mar. 1, 2013

(51) Int. Cl. G06F 9/38

(52) U.S. Cl. CPC G06F 9/3867
USPC 712/240

(57) ABSTRACT

Improved branch target buffers (BTBs) and methods of processing data in a microprocessor with a pipeline are provided. According to various embodiments, a BTB is provided that includes a non-return buffer, a return buffer, and a multiplexer. The non-return buffer is designed to store a multiple of non-return entries. Each non-return entry corresponds to a non-return type instruction. The return buffer is designed to store a plurality of return entries that each correspond to a return type instruction. Additionally, the return buffer may generate a control signal. The multiplexer also generates a control signal and outputs either data from the non-return buffer or data from a return prediction stack (RPS). Whether the multiplexer returns data from the non-return buffer or the RPS depends on the control signal.

### BACKGROUND

1. Field of the Invention

The invention generally relates to microprocessors and is of particular relevance to microprocessors that employ a pipeline with a branch target buffer (BTB).

2. Related Art

A BTB is typically a small cache of memory associated with a pipeline in a processor. A BTB is used to predict the target of a branch that is likely to be taken by comparing an instruction address against previously executed instruction addresses that have been stored in the BTB. This can save time in processing because it allows the processor to “skip” the step of computing a target address; instead it can just look it up in the BTB. Accordingly, the frequency with which a BTB can generate a “hit” for the target address directly impacts the speed with which an instruction can be executed. That is, the speed of execution is directly related to the number of entries a BTB can store. Traditionally, the only way to increase the number of entries a BTB could store was by increasing the size of the buffer.

### BRIEF SUMMARY OF THE INVENTION

Given that space is at a premium in modern microprocessors, it would be desirable to increase BTB performance without having to increase the size of the buffer itself, Accordingly, what is needed is an improved BTB with an optimized hit rate and improved performance relative to previous buffers.

To that end, embodiments of the present disclosure relate to improved BTBs and methods of processing data that address these concerns. The improved BTBs facilitate improved power usage, faster execution and a more efficient return predition. According to various embodiments, a BTB is provided that includes a non-return buffer, a return buffer, and a multiplexer. The non-return buffer is designed to store a multiple of non-return entries. Each non-return entry corresponds to a non-return type instructions (e.g., unconditional jumps, conditional branches, etc.). The return buffer is designed to store a plurality of return entries that each correspond to a return type instruction. Additionally, the return buffer may generate a control signal. The multiplexer also generates a control signal and outputs either data from the non-return buffer or data from a return prediction stack (RPS). Whether the multiplexer returns data from the non-return buffer or the RPS depends on the control signal.

According to Various embodiments, the return butler determines whether one of the multiple of return entries contains a tag that corresponds to an instruction address. Further, the return buffer generates the control signal such that it causes the multiplexer to output data from the head of RPS when it determines that a tag corresponds to the instruction address and to output data from the non-return buffer when it determines that none of the plurality of return entries contains a tag that corresponds to the instruction address. The non-return buffer may also determine whether one of the multiple of non-return entries corresponds to the instruction address.

According to various embodiments a method of fetching and address using a BTB is provided. According to the method, data relating to an instruction address is received. It can then be determined whether one of a multiple of return entries stored in a return buffer corresponds to the instruction address. Data can be output from one of a return prediction stack (RPS) and a non-return buster based on the prediction.

The determination of whether a return entry corresponds to the instruction address includes determining whether one of the multiple of return entries contains a tag that corresponds to the instruction address. Additionally a control signal may be generated based on the determination. The control signal causes data from the RPS to be output when a determination that one of the return entries correspond to the instruction address. Conversely, the control signal may be generated to cause data from the non-return buffer to be output when it is determined that none of the return entries correspond to the instruction address.

BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art to make and use the invention.

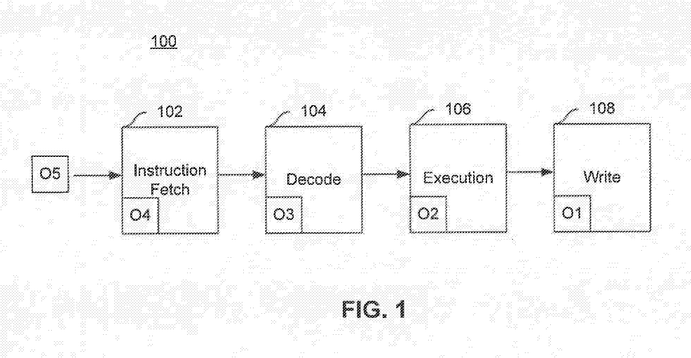

FIG. 1 is a functional block diagram depicting an instruction pipeline according to various embodiments.

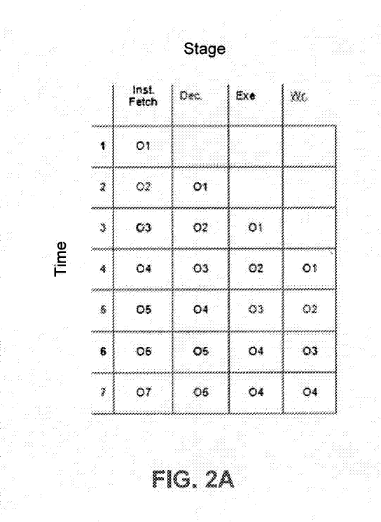

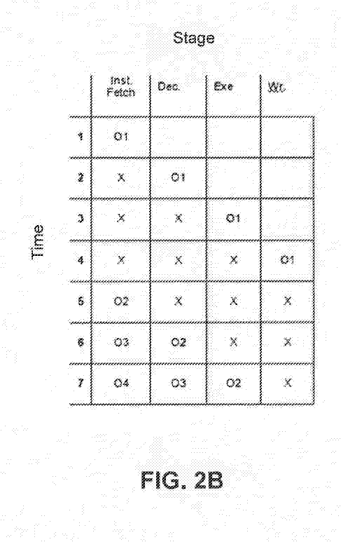

FIGS. 2A and 2B depict the operation of as instruction pipeline according to various embodiments.

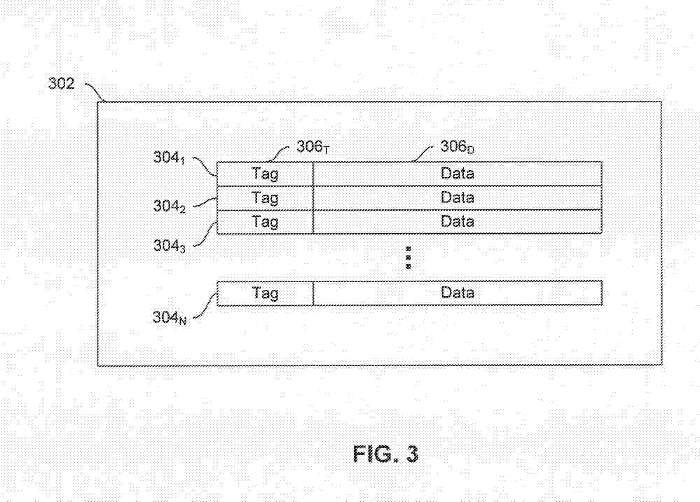

FIG. 3 depicts data stored in a branch target buffer according to various embodiments.

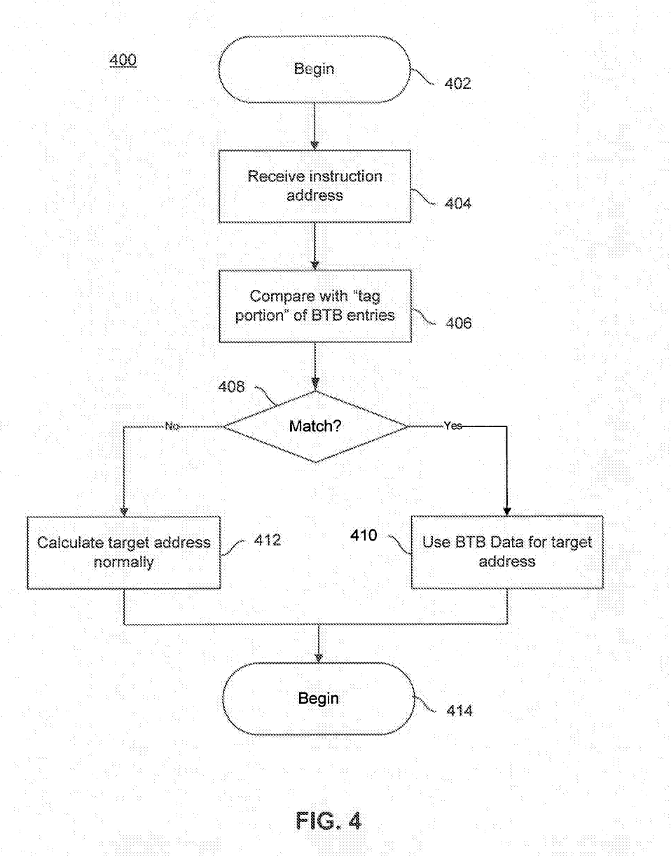

FIG. 4 is a flowchart depicting a method of etching at address according to various embodiments.

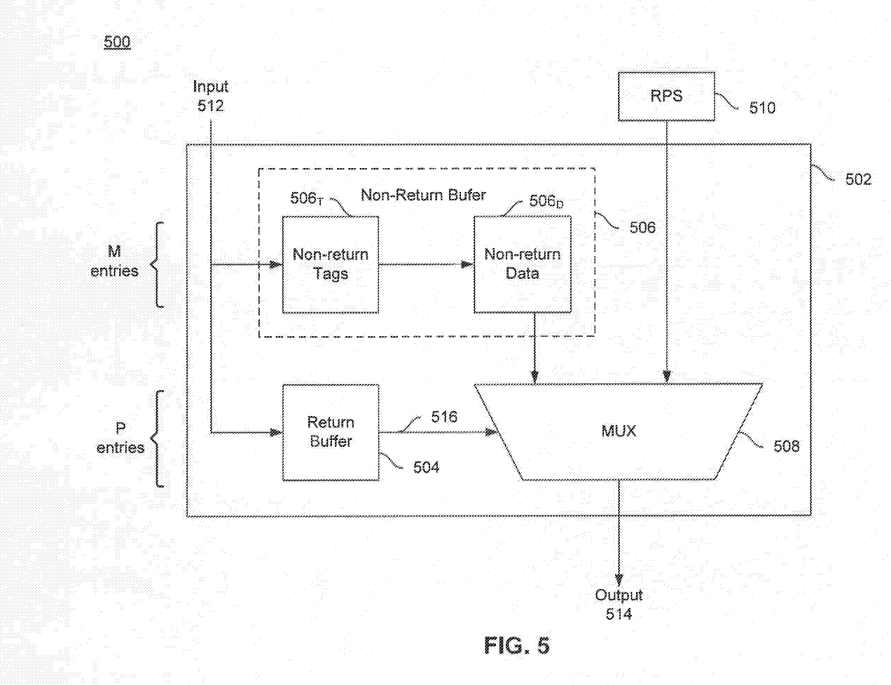

FIG. 5 is a functional block diagram depicting a branch target buffer according to various embodiments.

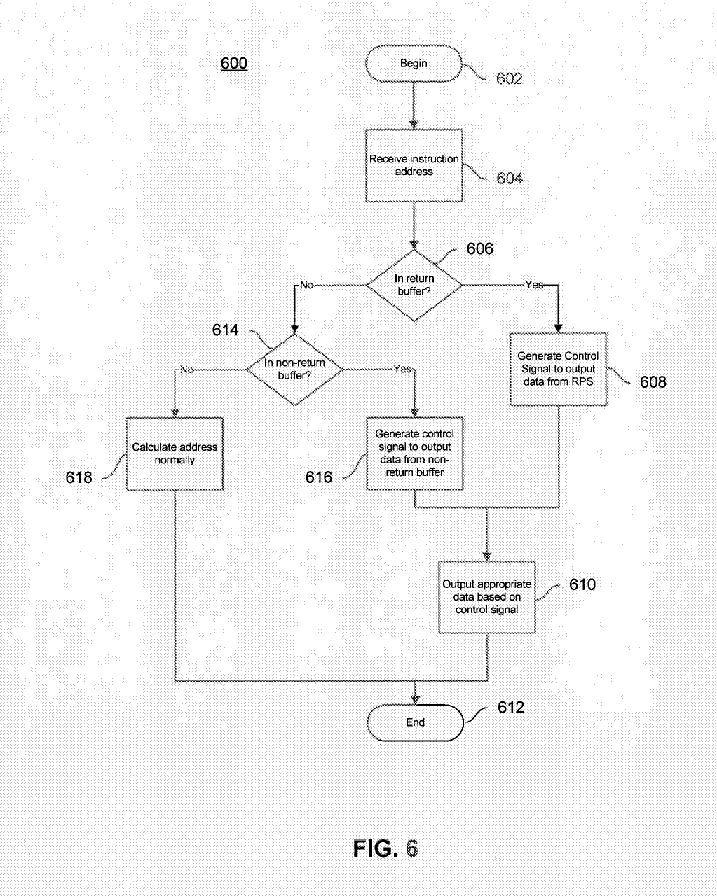

FIG. 6 is a flowchart depicting a method of fetching an address according to various embodiments.

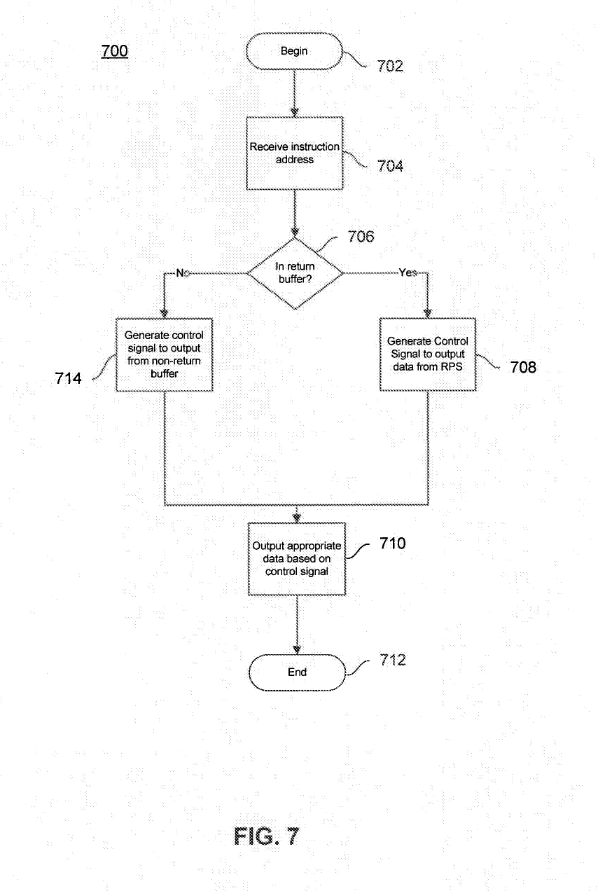

FIG. 7 is a flowchart depicting a method fetching an address according to various embodiments.

Features and advantages of the invention will become more apparent from the detailed description of embodiments of the invention set forth below when taken in conjunction with the drawings in which like reference characters identify corresponding elements throughout. In the drawings, like reference numbers generally indicate identical, functionally similar, and/or structurally similar elements. The drawings in which an element first appears is indicated by the leftmost digit(s) in the corresponding reference number.

### DETAILED DESCRIPTION

The following detailed description of embodiments of the invention refers to the accompanying drawings that illustrate exemplary embodiments. Embodiments described herein relate to a low power multiprocessor. In particular, the processor described herein has the benefit of using even less power than existing multiprocessors due to the improved scheme provided, below. Other embodiments are possible, and modifications can be made to the embodiments within the spirit and scope of this description. Therefore, the detailed description is not meant to limit the embodiments described below.

It should be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

FIG. 1 is a functional block diagram depicting a simplified pipeline 100 used for execution in a microprocessor according to various embodiments. In general, a pipeline can be used to execute several instructions in parallel. As shown in FIG. 1, the pipeline 100 may include an instruction fetch stage 102, a decode stage 104, an execution stage 106 and a write stage 108. An operation (e.g., operations O1-O5) might enter the pipeline 100 and flow through each of the stages in order. Furthermore, a separate independent operation may exist in each of the, components 102, 104, 106, and 108) of pipeline 100 at any given time. For instance, as shown in FIG. 1, operation O5 is shown waiting to enter the pipeline 100, operation O4 is shown in the instruction fetch stage 102 of the pipeline, The instruction fetch stage 102 is responsible for fetching instructions required to execute the operation (e.g., O4) based on, for example, a program counter associated with the operation.

FIG. 1 also depicts O3 in the decode stage 104 of pipeline 100. The decode stage 104 can perform the function of decoding instructions and updating a register renaming map (not shown). During the decoding process, each instruction can be associated with and/or assigned an instruction identification tag.

Operation O2 is depicted in FIG. 1 as being in the execution stage 106 of pipeline 100. Execution stage 106 is responsible for executing instructions and may include the necessary logic and/or circuitry to perform this task. The results of the execution of an operation (e.g., O1) by the execution stage 106 may be may be written to memory by the write stage 108, as depicted in FIG. 1.

FIG. 2A depicts how operations “flow” through a pipeline 100. As shown in FIG. 2A, at time 1, operation O1 is placed into the instruction fetch stage 102 of the pipeline 100. At time 2, O1 is moved to the decode stage 104 and O2 is placed in the instruction fetch stage 102. At time 3, O1 is moved to the execution stage 106, O2 is moved to the decode stage 104, and O3 is placed in the instruction fetch stage 102. At time 4, O1 is moved to the write stage 108, O2 is moved to the execution stage 106, O3 is moved to the decode stage 104, and O4 is placed in the instruction fetch stage 102. As can be seen in FIG. 2A, at time 4 and on, each of the stages has an instruction in it and the pipeline is operating as efficiently as possible. However, inefficiencies are present as each stage does not have an instruction present during each time period.

FIG. 2B illustrates a pipeline “flow” where 3 time periods of delay have been introduced according to various embodiments. As with FIG. 2A, operation O1 is placed into the instruction fetch stage 102 of the pipeline 100 at time 1. However, at time 2, there is a delay (represented by “X”) and no instruction is placed into the instruction fetch stage 102. O1, however, is still moved to the decoder stage 104. At time 3 another delay is introduced into the pipeline and, again, no operation is placed in the instruction fetch stage 102. Additionally, O1 is moved to the execution stage 106, leaving the decoder stage 104 empty as well. At time 4, another delay has resulted in another time period without an instruction being placed in the instruction fetch, stage 102. O1 has been moved to the write stage 108 leaving the decoder stage 104 and the execution stage 106 also empty. Accordingly, as can be seen, the three time periods of delay mean that the pipeline operates inefficiently for at least 6 time periods (e.g., time periods 2-7). Indeed, even if only one delay had been introduced, the pipeline would have been operating at less than full efficiency for at least 4 time periods (e.g., the length of the pipeline). Accordingly, it can be seen that it is best to avoid delay when possible.

One way in which delay can be avoided is to employ the use of a branch target buffer (BTB) 302 as depicted in FIG. 3, according to an embodiment. BTB 302 may form part of the instruction fetch stage 102. The BTB comprises a small cache memory that stores a number of entries (e.g., 304₁, 304₂, 304₃ . . . 304_{N}). Each entry contains, for instance, information identifying a previously executed instruction and the most recent target address. For instance, as shown in FIG. 3, BTB 302 contains entries 304₁, 304₂, 304₃ . . . 304_{N} such that each entry has a tag portion 306_{T} and a data portion 306_{D}. In an embodiment, tag portion 306_{T} contains information that identifies a previously executed instruction and the data portion 306_{D} contains information that identifies the target address of the corresponding previously executed instruction.

According to various embodiments, BTB 302 functions by comparing an instruction address against the tag portion 306: of its various entries, e.g., 304₁, 304₂, 304₃ . . . 304_{N}, to determine whether any of the entries 304₁, 304₂, 304₃ . . . 304_{N} correspond to the instruction address. If there is a match (or “hit” as sometimes called), then the associated data portion 306_{D} of that entry can be used to determine the target address of the branch. This saves the pipeline any delay associated with calculating the target address.

FIG. 4 is a flow chart illustrating a process 400 followed by a BTB 302, according to various embodiments. As shown in FIG. 4, the process 400 begins at step 402. BTB 302 receives an instruction address 404 at step 404.

The instruction address is then compared with the various entries (e.g., 304₁, 304₂, 304₃ . . . 304_{N}). In particular, according to various embodiments, the tag portion 306_{T} of the entries is used to compare the entries to the instruction address.

At step 408, method 400 determines whether any of the tag portions 306_{T} match or correspond to the instruction address. If it is determined that there is a match at step 408, then BTB 302 uses data portion 306_{D} to determine the appropriate target address for the instruction. If however, it is determined that there is not a match at step 408, then the instruction fetcher 102 is forced to calculate the target address normally, which can incur a delay according to various embodiments. At step 414, method 400 ends.

An interesting situation arises when return-type instructions are part of BTB 302. Return type instructions comprise register-indirect branches and can, therefore, have dynamic target prediction. That is, for the same program counter, the next fetch address could be different, which depends on the instruction code path on which the return instruction was fetched and executed. This property of return type instructions puts pressure on BTB 302 sizing. However, it is possible to divide BTB 302 into a dedicated return buffer and a dedicated non-return buffer to reduce this pressure. Such a scheme is illustrated in FIG. 5.

FIG. 5 is a functional block diagram depicting a system 500 that contains a BTB 502 and a return prediction stack (RPS) 510. BTB 502 comprises a return buffer 504, a non-return buffer 506, and a multiplexer 508. Additionally, BTB 502 has an input 512 and an output 514.

According to various embodiments, return buffer 504 is configured to stole a number of entries that correspond to return type instructions. As shown in FIG. 5, return buffer 504 is capable of holding P entries, each of which can hold T-bit tag data. Each of the entries represents the program counter of some form of return type instruction. According to some embodiments, the entries in return baler 504 may not have an associated target address or data portion 306_{D} associated with them. Return buffer may also be configured generate a control signal 516 that is based on whether a received instruction address corresponds to one of its entries. Because return buffer 504 only contains tags and not target addresses, hits from the return buffer resolve quickly. This can result in a more efficient return prediction, which, in turn, yields improved processing speeds.

Non-return buffer 506 contains a number of entries M relating to non-return type instructions. In an embodiment, each entry contains a tag portion 506_{T} and a data portion 506_{D}. Tag portion 506_{T} can contain information that identifies a previously executed instruction and the data portion 506_{D} contains information that identifies the target address of the corresponding previously executed instruction. According to some embodiments, the number of entries M in the non-return buffer 506 may be greater than the number of entries P in the return buffer 504.

Multiplexer 508 multiplexes between data received from non-return buffer 506 and RPS 510 according to various embodiments. The multiplexer 508 may, for instance, receive control signal 516 from return buffer 508 and, based on the control signal send either non-return data 506_{D} or data from RPS 510 to output 514. Return buffer 504 generates control signal 516 that causes multiplexer 508 to output data from RPS 510 when it has an entry that corresponds to an input instruction address. Conversely, return buffer 504 generates control signal 516 that causes multiplexer 508 to output data 506_{D} from non-return buffer 506 when there are no entries that correspond to an input instruction address in return buffer 504.

Return prediction stack (RPS) 510 contains a number of entries that act as a mechanism for predicting return instructions. In an embodiment, each entry in RPS 510 corresponds to a return type instruction and includes a target address of the associated instruction. As noted above, to improve the speed of a hit from return buffer 504 and thus the BTB 502, none of the return buffer's entries P contain target addresses for the corresponding instructions. Instead, the target address for return type instructions are stored in the RPS 510. Accordingly, when there is a hit in return buffer 504 the target address is taken from the head of the RPS 510. This is why multiplexer 508 may receive control signal 516 that causes it to output data (e.g., a target address) from the RPS when such a hit occurs.

FIG. 6 depicts a method 600 of fetching a target address using BTB 302, according to various embodiments. The method begins at step 602. At step 604 an instruction address is received for determination of whether it is in BTB 302.

At step 606, the method determines whether the received instruction address is in Return buffer 504. According to various embodiments, the determination of whether the received address is in return buffer 504 can be made by determining whether any of the tags stored in return buffer 504 correspond to the received instruction address.

If at step 606, the determination is made that the instruction address corresponds to one of the entries in return buffer 504, then return buffer 504 generates control signal 516 that causes multiplexer 508 to output data from RPS 510 when it has an entry that corresponds to an input instruction address at step 608.

At step 610, the appropriate data can be output based on the control signal. Namely, because return buffer 504 has detected that the instruction address corresponds to one of its entries (e.g., a “hit”) it generates an appropriate control signal to cause multiplexer 508 to output data from RPS 510. The data from RPS 510 corresponds to the target address appropriate for the instruction address. Once the data from RPS 510 is output by multiplexer 508, the process can end at step 612.

However, if, at step 606, the determination is made that the instruction address corresponds to none of the entries in the return buffer, then it is determined whether any of the entries in non-return buffer 506 corresponds to the instruction address at step 614. According to various embodiments, this determination can be made by comparing tag portion 506_{T} of the non-return buffer with the instruction address to determine if there is a corresponding entry.

If it is determined that the instruction address corresponds one of the entries in the non-return buffet 506 (e.g., if there is a “hit”), then, a control signal can be generated to output data from non-return buffer 506 at step 616. At step 610, the multiplexer, based on the control signal, outputs data 506_{D} from non-return buffer 506.

If, at step 614, it is determined that there is no “hit” in non-return buffer 506, then the instruction fetch stage 102 must calculate the target address and incur a delay, as discussed above. The method 600 ends at step 612.

Method 600 depicts determining whether there is a “hit” in the non-return buffer when there is no hit in the return buffer at step 606. However, it is also possible to simply assume a “hit” in the non-return buffer according to various embodiments. FIG. 7 depicts such a scenario.

FIG. 7 is a flowchart depicting a method 700 of fetching a target address, according to various embodiments. The method begins at step 702. At step 704 an instruction address is received for determination of whether it is in BTB 302.

At step 706, the method determines whether the received instruction address is in return buffer 504. According to various embodiments, the determination of whether the received address is in return buffer 504 can be made by determining whether any of the tags stored in the return buffer 504 correspond to the received instruction address.

If, at step 706, the determination is made that the instruction address corresponds to one of the entries in return buffer 504, then return buffer 504 generates a control signal 516 that causes multiplexer 508 to output data from RPS 510 when it has an entry that corresponds to an input instruction address at step 708.

At step 710, the appropriate data can be output based on the control signal. Namely, because return buffer 504 has detected that the instruction address corresponds to one of its entries (e.g., a “hit”) it generates an appropriate control signal to cause multiplexer 508 to output data from RPS 510. The data from RPS 510 corresponds to the target address appropriate for the instruction address. Once the data from RPS 510 is output by multiplexer 508, the process ends at step 712.

If, at step 706, the determination is made that the instruction address corresponds to none of the entries in the return buffer, then it can be assumed that the non-return buffer will have a hit and the control signal can be set based on that assumption. Accordingly, control signal 516 can be set to cause multiplexer 508 to output 506_{D} from non-return buffer 506. And at step 712, the appropriate data can be output.

While various embodiments of the present invention have been described above, it should be understood that they have been presented by way of example, and not limitation. It will be apparent to persons skilled in the relevant computer arts that various changes in form and detail can be made therein without departing from the spirit and scope of the invention. Furthermore, it should be appreciated that the detailed description of the present invention provided herein, and not the summary and abstract sections, is intended to be used to interpret the claims. The summary and abstract sections may set forth one or more but, not all exemplary embodiments of the present invention as contemplated by the inventors.

For example, in addition to implementations using hardware (e.g., within or coupled to a Central Processing Unit (“CPU”), microprocessor, microcontroller, digital signal processor, processor core, System on Chip (“SOC”), or any other programmable or electronic device), implementations may also be embodied in software (e.g., computer readable code, program code, instructions and/or data disposed in any form, such as source, object or machine language) disposed. for example, in a computer usable (e.g., readable) medium configured to store the software. Such software can enable, for example, the function, fabrication, modeling, simulation, description, and/or testing of the apparatus and methods described herein. For example, this can be accomplished through the use of general programming languages (e.g., C, C++), GDSII databases, hardware description languages (HDL) including Verilog HDL, VHDL, SystemC Register Transfer Level (RTL) and so on, or other available programs, databases, and/or circuit (i.e., schematic) capture tools. Embodiments can be disposed in any known non-transitory computer usable medium including semiconductor, magnetic disk, optical disk (e.g., CD-ROM, DVD-ROM, etc.).

It is understood that the apparatus and method embodiments described herein may be included in a semiconductor intellectual property core, such as a microprocessor core (e.g., embodied in HDL) and transformed to hardware in the production of integrated circuits. Additionally, the apparatus and methods described herein may be embodied as a combination of hardware and software. Thus, the present invention should not be limited by any of the above-described exemplary embodiments, but should be defined only in accordance with the following claims and their equivalence. It will be appreciated that embodiments using a combination of hardware and software may be implemented or facilitated by or in cooperation with hardware components enabling the functionality of the various software routines, modules, elements, or instructions, e.g., the components noted above.

The embodiments herein have been. described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

What is claimed is:

1. A branch target buffer (BTB), comprising:
a non-return buffer configured to store a plurality of non-return entries, each of which corresponds to a non-return type instruction;
a return buffer configured to store a plurality of return entries, each of which corresponds to a return type instruction, and further configured to generate a control signal; and
a multiplexer configured to receive the generated control signal and output either data from the non-return buffer or data fro n a return prediction stack (RPS) based on the control signal.

2. The BTB of claim 1, wherein the return buffer is further configured to determine whether one of the plurality of return entries contains a tag that corresponds to an instruction address.

3. The BTB of claim 2, wherein the return buffer is further configured to generate the control signal such that it causes the multiplexer to output data from the RPS in response to determining that one of the plurality of return entries contains a tag that corresponds to the instruction address.

4. The BTB of claim 2, wherein the return buffer is further configured to generate the control signal such that it causes the multiplexer to output data from the non-return buffer in response to determining that none of the plurality of return entries contains a tag that corresponds to the instruction address.

5. The BTB of claim 1, wherein the non-return buffer is configured to store a greater number of entries than the return buffer.

6. The BTB of claim 1, wherein the plurality of non-return entries comprises a tag portion and a data portion that correspond to the non-return type instruction.

7. The BTB of claim 1, wherein the plurality of return entries comprises tags representing a program counter of a return type instruction.

8. The BTB of claim 1, wherein the non-return buffer comprises a tag portion and a data portion.

9. The BTB of claim 1, the non-return buffer is configured to determine whether one of the plurality of non-return entries corresponds to an instruction address.

10. The BTB of claim 1, wherein none of the return entries contain a target address.

11. A method of fetching an address using a branch target buffer (BTB), comprising:
receiving data relating to an instruction address;
determining whether one of a plurality of return entries stored in a return buffer correspond to the instruction address;
outputting data from a return prediction stack (RPS) and a non-return buffer based on the determination.

12. The method of claim 11, wherein the determining comprises whether one of the plurality of return entries contains a tag that corresponds to the instruction address.

13. The method of claim 11, further comprising generating a control signal based on the determination.

14. The method of claim 13, further comprising outputting data from the RPS based on the generated control signal when the determination is made that one of the plurality of return entries contains a tag that corresponds to the instruction address.

15. The method of claim 13, further comprising outputting data from the non-return buffer based on the generated control signal when the determination is made that none of the plurality of return entries contains a tag that corresponds to the instruction address.

16. The method of claim 11, further comprising storing a plurality of non-return entries in the non-return buffer wherein each entry corresponds to a non-return type instruction.

17. The method of claim 16, further comprising determining that one of the plurality of non-return entries corresponds to an instruction address.

18. The method of claim 16, wherein each of the non-return entries comprises a tag portion and a data portion.

19. The method of claim 11, wherein each of the plurality of return entries comprise tags representing a program counter of a return type instruction.

20. The method of claim 1, wherein none of the return entries contain a target address.
